(19) United States
(12) Patent Application Publication
(10) Pub. No.: US 2024/0049119 A1
(43) Pub. Date: Feb. 8, 2024

(54) IMPROVEMENT TO PUBLIC LAND MOBILE NETWORK SEARCH AT SWITCH-ON FOR WIRELESS COMMUNICATIONS

(71) Applicant: QUALCOMM Incorporated, San Diego, CA (US)

(72) Inventors: Hao ZHANG, Shanghai (CN); Aimin SHANG, Shanghai (CN); Jian LI, Shanghai (CN)

(21) Appl. No.: 18/256,034

(22) PCT Filed: Feb. 5, 2021
(86) PCT No.: PCT/CN2021/075400

§ 371 Date: Jun. 5, 2023

(51) Int. Cl. H04W 48/16

(52) U.S. Cl. CPC H04W 48/16; H04W 84/042

(57) ABSTRACT

Apparatus, methods, and computer-readable media for improvements to public land mobile network (PLMN) search at user equipment (UE) switch-on for wireless communications are disclosed herein. A user equipment (UE) may determine to request for a first service associated with a first radio access technology (RAT). The UE may determine whether an identifier of a first registered public land mobile network (RPLMN) associated with the first RAT is present in the UE. The UE may camp on a first cell of the first RPLMN when the identifier of the first RPLMN is present in the UE.

### BACKGROUND

### Technical Field

The present disclosure relates generally to communication systems, and more particularly, to improvements to public land mobile network (PLMN) search at user equipment (UE) switch-on for wireless communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. As the demand for mobile broadband access continues to increase, further improvements in LTE and 5G NR technologies and beyond may be desired. These improvements may also be applicable to other multi-access technologies and the telecommunication standards that employ these technologies. For example, as the next generation of wireless communications come into existence, current PLMN searches may become a hindrance to achieving adequate or improved levels of wireless communications. Thus, improvements in wireless communication operations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

When a multi-mode UE, e.g., a UE that is capable of operating across different standards and radio access technologies (RAT), goes out-of-service (OOS) and/or transitions into a switch-on state, the Non-Access Stratum (NAS) layer of the UE sends a service request to a radio resource on the UE to search for service on a PLMN from which the UE was most recently receiving service. The most recent PLMN may be referred to as a registered PLMN (RPLMN). When the UE is operating in 5G NR or LTE, the radio resource may be referred to as a radio resource control (RRC).

Generally, the PLMN for a standalone service is different against other RATs (e.g., non-standalone) as deployed by a same operator, while RPLMN is unique and applicable to all supported RATs. In a case scenario where the RPLMN indicates a first PLMN identity (e.g., PLMN_1) and the corresponding RAT is LTE, when the UE determines to request for a standalone service (e.g., 5G NR), the UE NAS layer may first request service on a default PLMN using the first PLMN identity (e.g., PLMN_1). However, the PLMN identity of the standalone service is a second PLMN (e.g., PLMN_2). In this regard, the PLMN identities may not correspond to a particular RAT and/or service. As such, the UE may spend a large amount of time performing a large number of scans in order to acquire service. As a result, there may be an undesirable delay in the UE acquiring service on a specific RAT (e.g., standalone). As such, an optimized search for service when a multi-mode UE is powered on (or switched on after going out-of-service) is desired.

The subject technology provides for a UE to search for service on a last RPLMN of a particular RAT when the service request relates to that particular RAT when the UE transitions into a switch-on state. The subject technology may provide several advantages in the technique of PLMN search and selection including, but not limited to, (1) achieving a decrease in PLMN search duration when a RAT change is detected and/or performed, and (2) providing unique PLMN identities (or different PLMN identities) according to the specific RAT.

In an aspect of the disclosure, a method, a computer-readable medium, and an apparatus are provided. The apparatus may be a user equipment. The apparatus is configured to determine to request for a first service associated with a first radio access technology. The apparatus also may be configured to determine whether an identifier of a first registered public land mobile network associated with the first RAT is present in the UE. The apparatus also may be configured to camp on a first cell of the first RPLMN when the identifier of the first RPLMN is present in the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a subframe, respectively.

FIG. 3 is a block diagram of a first wireless communication device in communication with a second wireless communication device.

FIG. 4 is a diagram illustrating an example of a PLMN selection procedure in a network environment, in accordance with implementations of the present disclosure.

FIG. 5 is a diagram illustration a communication flow for RPLMN selection and registration in accordance with some aspects of the present disclosure.

FIG. 6 is a flowchart illustrating an example process of wireless communication that supports improvements to PLMN search at switch-on in accordance with some aspects of the present disclosure.

FIG. 7 is a conceptual data flow diagram illustrating the data flow between different components in an example apparatus in accordance with some aspects of the present disclosure.

FIG. 8 is a diagram illustrating an example of a hardware implementation for an apparatus employing a processing system in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A PLMN is a network that is operated by an administrator or a recognized operating agency (ROA) (which may both be referred to as an “operator”) for the specific purpose of providing land and/or mobile telecommunication services to the public. A PLMN is identified by PLMN identifier (PLMN ID) which includes a Mobile Country Code (MCC) and a Mobile Network Code (MNC). Each operator providing mobile services has its own PLMN identifier. PLMNs interconnect with other PLMNs and Public switched telephone networks (PSTN) for telephone communications and/or with Internet service providers for data and Internet. Access to PLMN services may be achieved via an air interface involving radio communications between mobile phones and/or other wireless-enabled user equipment (UE) and land-based radio transmitters, radio base stations, and/or fiber optic networks.

A subscriber to wireless services may be associated with a subscriber profile. The subscriber's profile may be stored in association with a home public land mobile network (HPLMN), which simply may be a PLMN associated with a wireless service to which the subscriber has a relationship and/or subscription. If the subscriber roams to another PLMN by, for example, leaving a geographic area associated with the subscriber's HPLMN, the subscriber may still receive subscription information from its HPLMN even though the subscriber may now be receiving service from a visited public land mobile network (VPLMN). A HPLMN for one subscriber may be a VPLMN for another subscriber.

A UE may perform a PLMN search procedure to select a PLMN for communication services (e.g., cell camping, registration, or other communication activities). The PLMN selection procedure may include various operations, such as searching for a number of available PLMNs and selecting a PLMN among them. The PLMN selection procedure is generally followed by a cell selection procedure, whereby a cell of the selected PLMN (or another PLMN in some scenarios) may be chosen for communication services. In general, multiple cells may belong to a same PLMN, and multiple PLMNs may share a same cell. As used herein, the term “procedure,” as in “PLMN selection procedure” or “cell selection procedure,” may refer to a series of actions or operations, as a whole, conducted for a specific purpose, e.g., to select a PLMN, or to select a cell, respectively.

When a multi-mode UE, e.g., a UE that is capable of operating across different standards and radio access technologies (RAT), goes out-of-service (00S) and/or transitions into a switch-on state, the Non-Access Stratum (NAS) layer of the UE sends a service request to a radio resource on the UE to search for service on a PLMN from which the UE was most recently receiving service. The most recent PLMN may be referred to as the registered PLMN or RPLMN. The RPLMN may be the HPLMN or VPLMN. When the UE is operating in 5G NR or LTE, the radio resource may be referred to as a radio resource control (RRC).

Generally, the PLMN for a standalone service is different against other RATs (e.g., non-standalone) as deployed by a same operator, while RPLMN is unique and applicable to all supported RATs. In a case scenario where the RPLMN indicates a first PLMN identity (e.g., PLMN_1) and the corresponding RAT is LTE, when the UE determines to request for a standalone service (e.g., 5G NR), the UE NAS layer may first request service on a default PLMN using the first PLMN identity (e.g., PLMN_1). However, the PLMN identity of the standalone service is a second PLMN (e.g., PLMN_2). In this regard, the PLMN identities may not correspond to a particular RAT and/or service. As such, the UE may spend a large amount of time performing a large number of scans in order to acquire service. As a result, there may be an undesirable delay in the UE acquiring service on a specific RAT (e.g., standalone). As such, an optimized search for service when a multi-mode UE is powered on (or switched on after going out-of-service) is desired.

The subject technology provides for a UE to search for service on a last RPLMN of a particular RAT when the service request relates to that particular RAT when the UE transitions into a switch-on state. The subject technology may provide several advantages in the technique of PLMN search and selection including, but not limited to, (1) achieving a decrease in PLMN search duration when a RAT change is detected and/or performed, and (2) providing unique PLMN identities (or different PLMN identities) according to the specific RAT.

The UE may search for service on a RAT-by-RAT basis. Rather than performing a scan in a RAT to locate a PLMN that may not support a requested service and increase the likelihood of having to perform multiple scans until the requested service can be acquired, the UE may perform a scan of the last registered PLMN for the requested service, such as a first RPLMN associated with a first RAT, according to an acquisition data structure. If a signal on which service may be acquired is found, the UE may attempt to camp on the signal and register with the PLMN indicated by the first RPLMN. The acquisition data structure includes information related to RPLMNs on which the UE is most likely to find a signal where service may be acquired within each registered PLMN that is accessible by the UE for each RAT supported by each RPLMN. More particularly, the acquisition data structure may include a list of RPLMNs that are each associated with a RAT identifier and a PLMN identifier.

It is often the case that a UE may find service in a RAT associated with a RPLMN within the acquisition data structure at PLMNs associated with the RAT. In other words, the acquisition data structure may include RPLMN-RAT combination information that indicates the most promising candidates for camping and registration.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

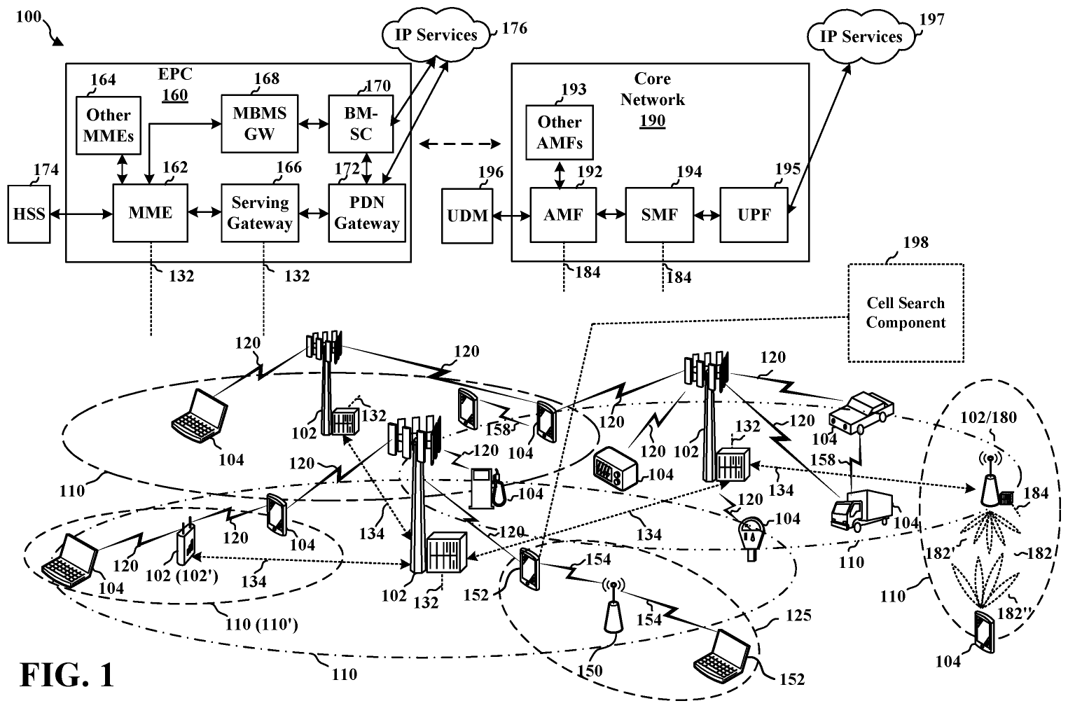

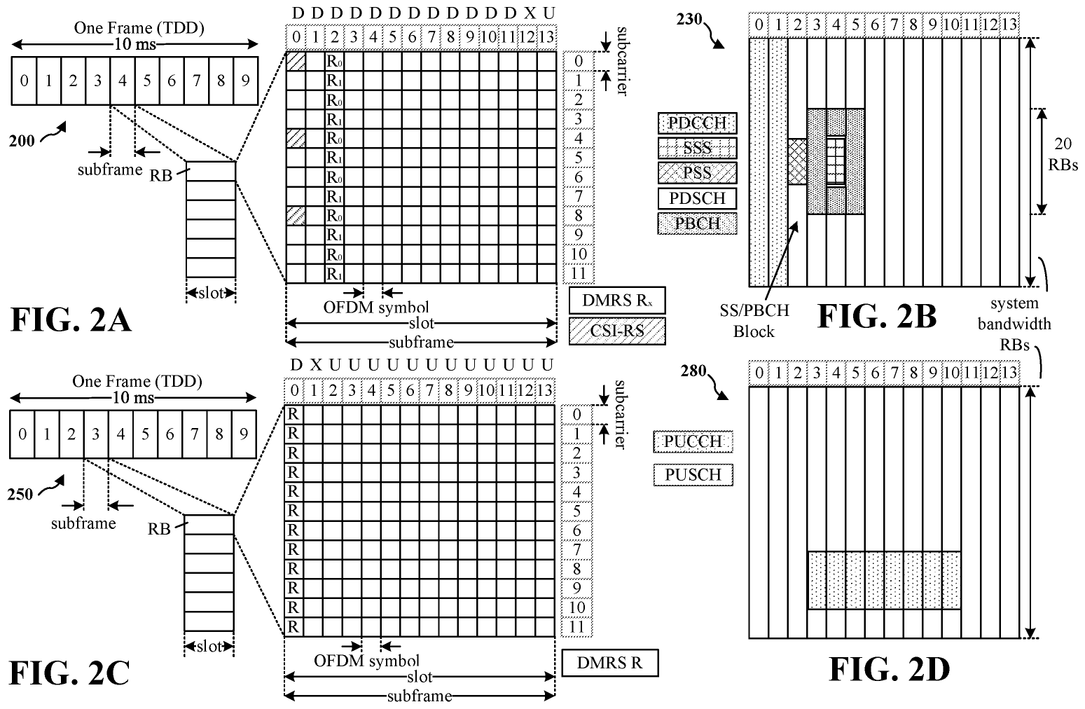

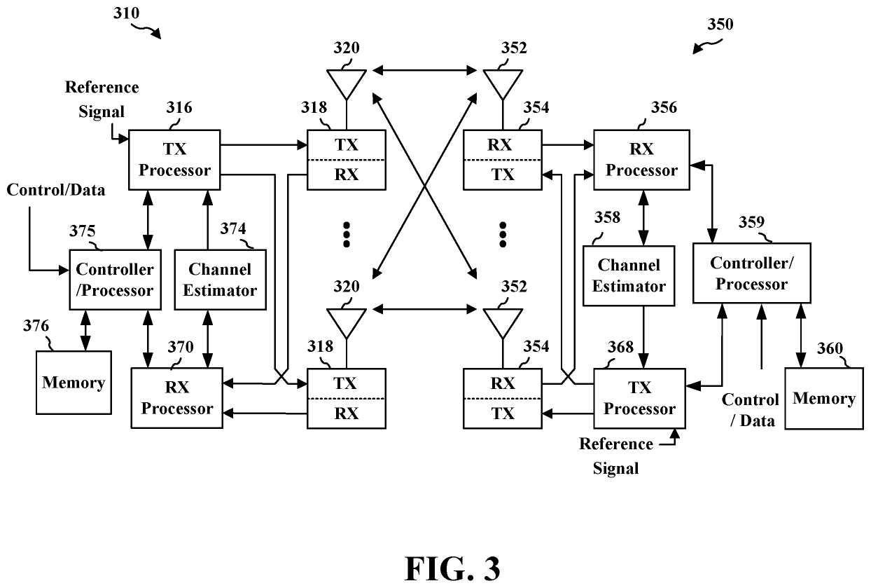

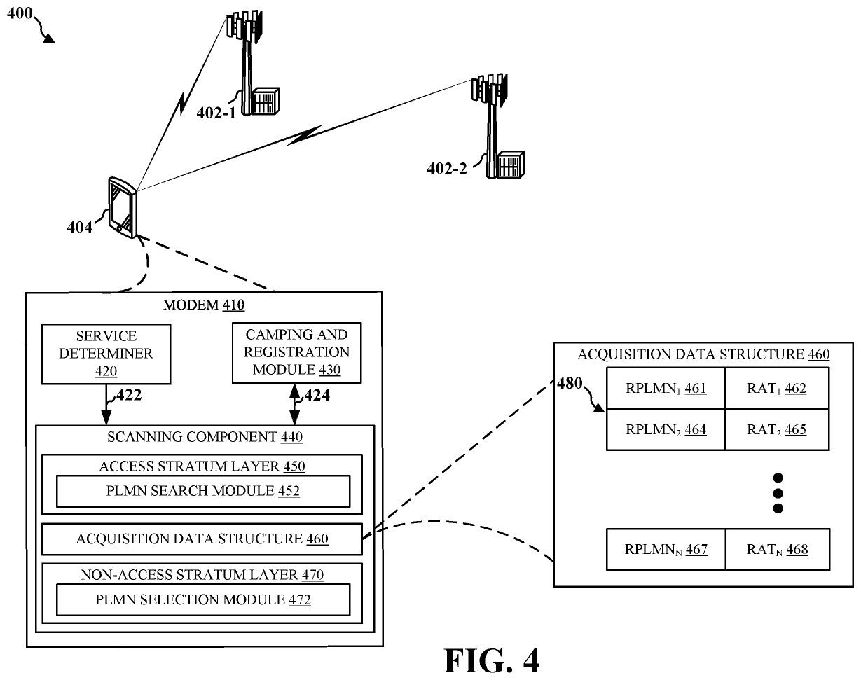

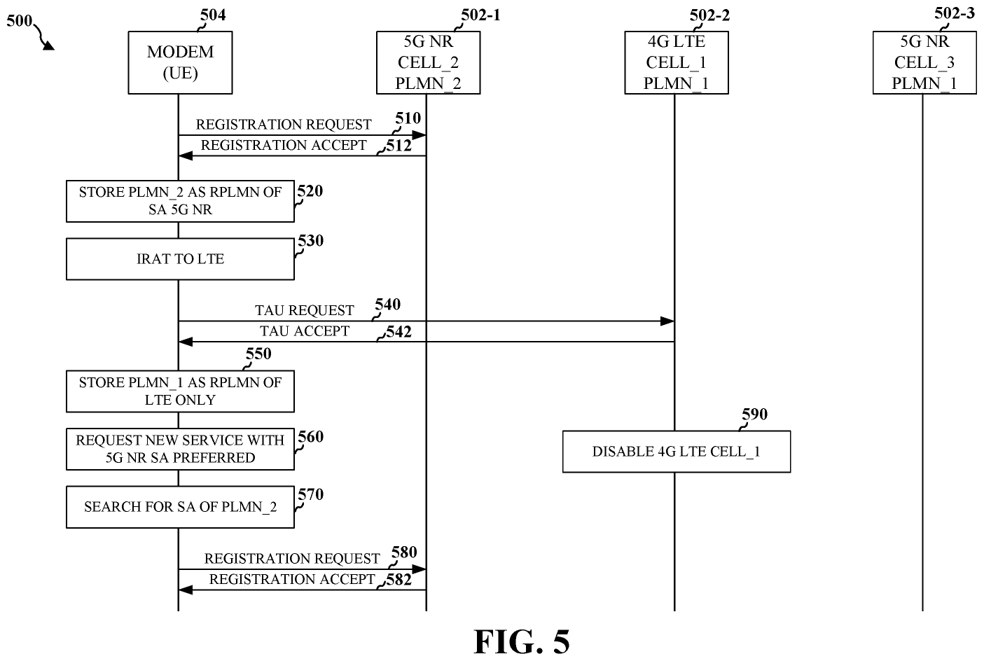

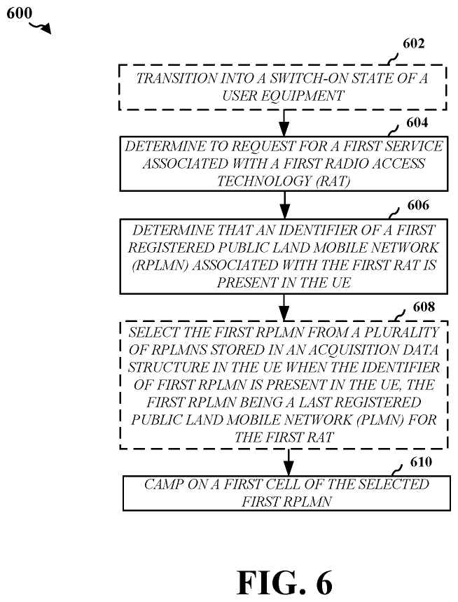

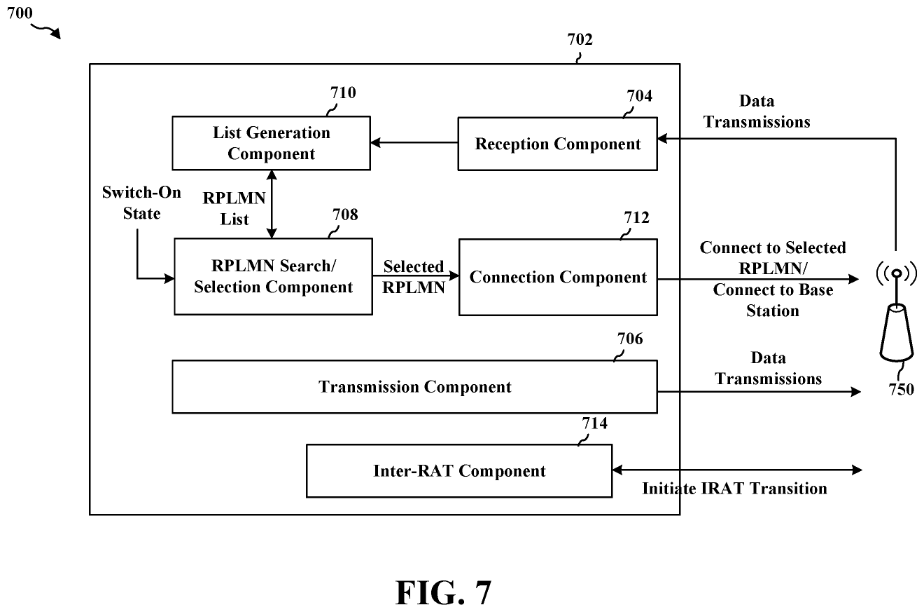

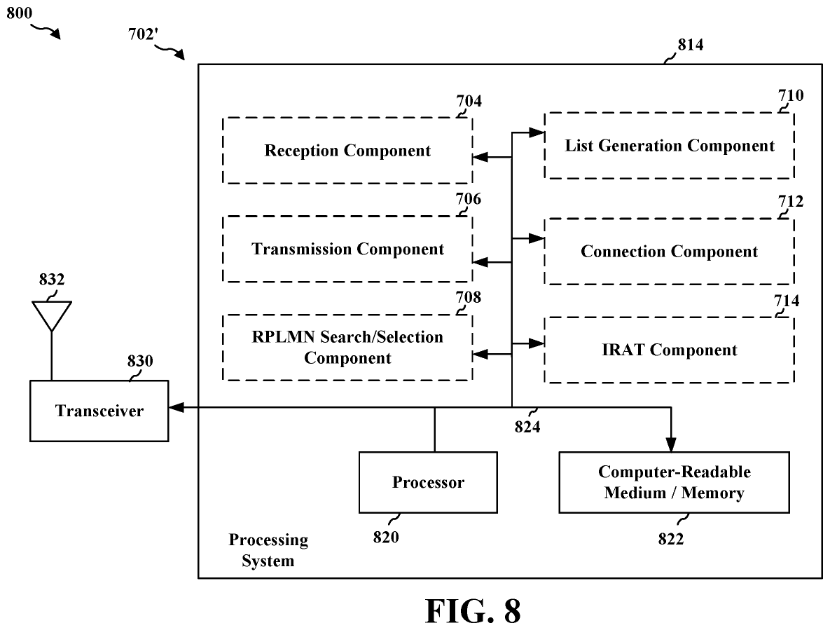

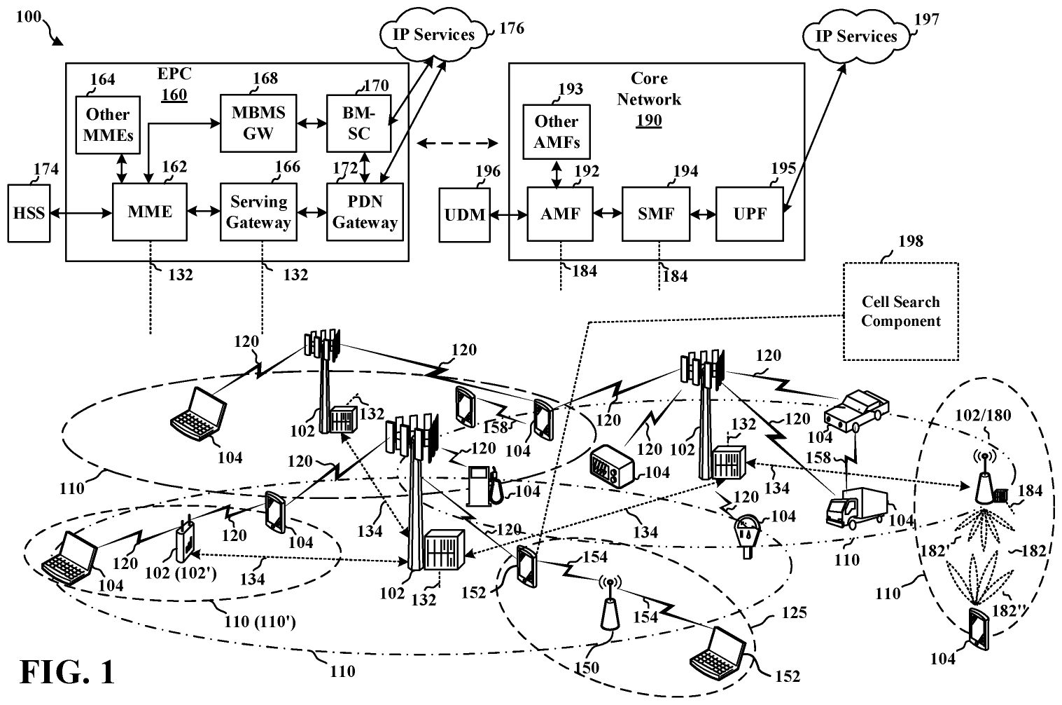

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. The base stations 102 may operate one or more “cells.” The term “cell” can generally refer to a logical entity used for communication with a base station (e.g., over one or more carriers), and in some context, may also refer to a portion of a geographic coverage area (e.g., a sector) over which the logical entity operates. An identifier (e.g., a cell identity) may be associated with a cell to distinguish the cell from another cell. The UEs 104 may register and communicate with one or more cells (e.g., serving cells) while monitoring other cells (e.g., neighbor cells).

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a WLAN 125 having a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user IP packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IMS, a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

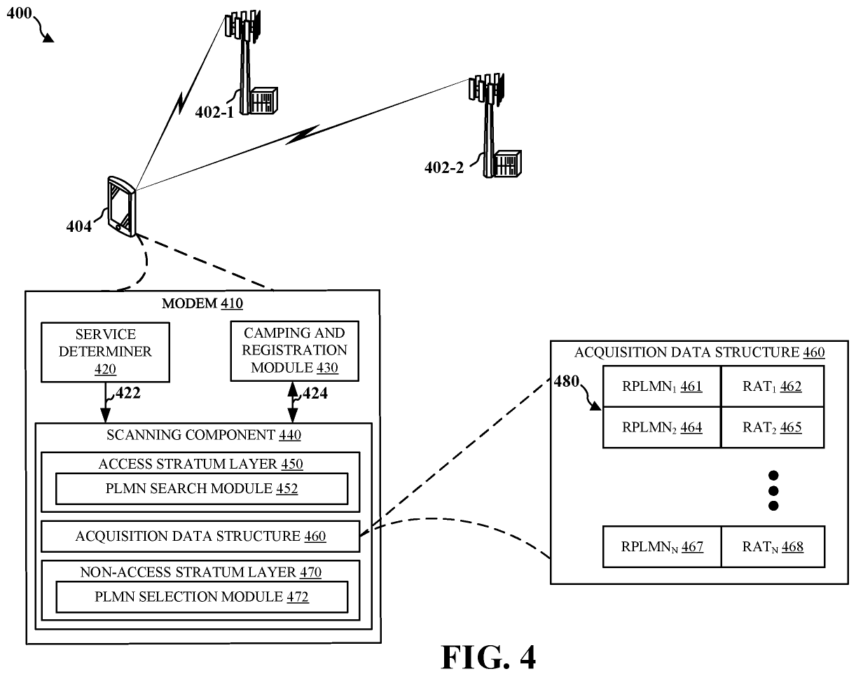

Referring again to FIG. 1, in certain aspects, the UE 104 may include a cell search component 198, which is configured to determine to request for a first service associated with a first radio access technology. The cell search component 198 also may be configured to determine whether an identifier of a first registered public land mobile network associated with the first RAT is present in the UE. The cell search component 198 also may be configured to camp on a first cell of the first RPLMN when the identifier of the first RPLMN is present in the UE. Further related aspects and features are described in more detail in connection with FIGS. 4-8. Although the following description may be focused on 5G NR, the concepts described herein may be applicable to other similar areas, such as LTE, LTE-A, CDMA, GSM, and other wireless technologies.

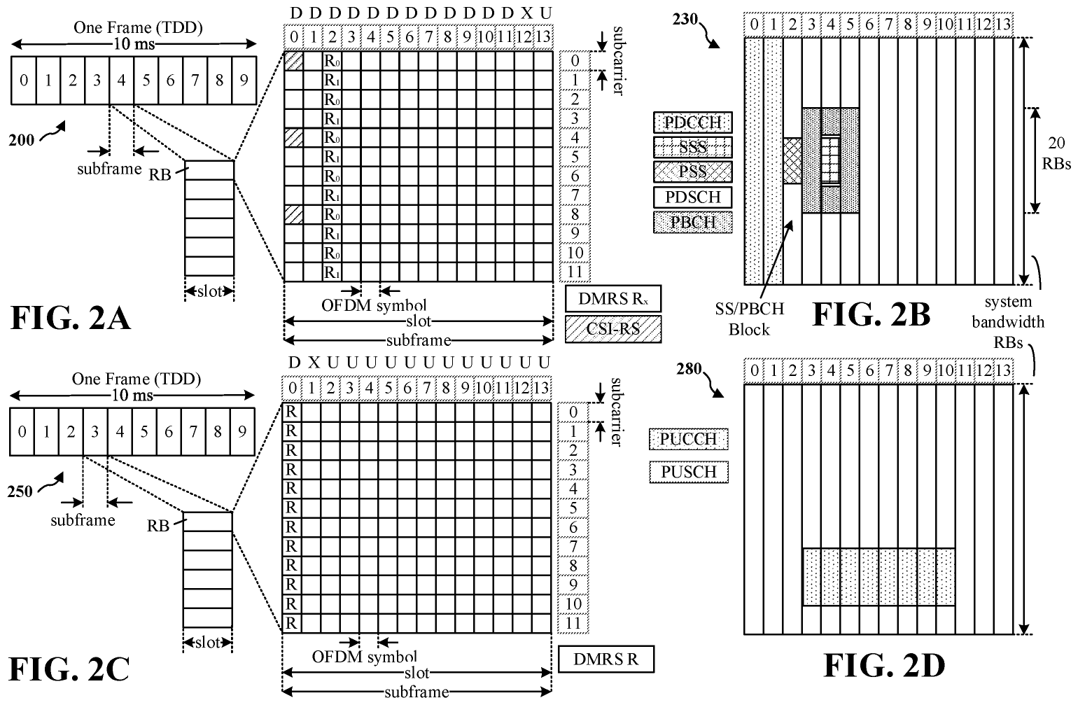

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DCI, or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. In some aspects, the DCI carries DFI. The DFI may be used for handling the HARQ-ACK protocol in conjunction with a CG transmission in the uplink. The DFI may be transmitted using the PDCCH scrambled with CS-RNTI, such that no new physical channel is defined. Rather, the DCI format 0_1 frame structure is reused with a DFI flag indicating whether the remainder of the DCI is to be interpreted as an uplink scheduling grant or downlink feedback information. To distinguish usage of the DCI for activation/deactivation CG transmission and DFI, a 1 bit flag (serving as an explicit indication) is used, when type 1 and/or type 2 CG PUSCH is configured. If the DFI flag is set, the remainder of the DCI is interpreted as a bitmap to indicate positive or negative acknowledgment for each HARQ process contained within the DFI. The DFI size may be aligned with the UL grant DCI format 0_1 size. For example, reserved bits may be included to ensure the overall size of the DFI is equivalent to the DCI format 0_1 frame structure size regardless whether the DCI format 0_1 frame structure size carries an uplink grant or downlink feedback information, thus, the number of blind decoding attempts is not increased. In this regard, the UE blind decoding complexity is not increased due to matching sizes. In some aspects, the content of DFI includes: (1) a 1 bit UL/downlink (DL) flag, (2) a 0- or 3-bit carrier indicator field (CIF), 3 bits are used in the case of a cross carrier scheduled is configured, (3) the 1-bit DFI flag, used to distinguish between DCI format 0_1 based activation/deactivation and DFI, (4) 16-bit HARQ-ACK bitmap, (5) 2-bit transmit power control (TPC) command, and (6) any zero-padding to match the length of the DCI format 0_1 frame structure.

A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RB s in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

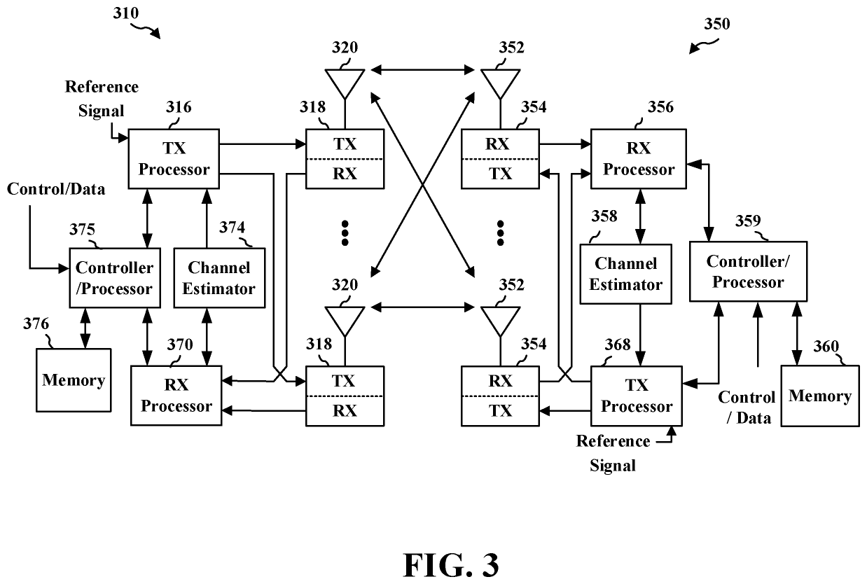

FIG. 3 is a block diagram of a base station 310 in communication with a UE 350 in an access network. In the DL, IP packets from the EPC 160 may be provided to a controller/processor 375. The controller/processor 375 implements layer 3 and layer 3 functionality. Layer 3 includes a radio resource control (RRC) layer, and layer 3 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TB s), demultiplexing of MAC SDUs from TB s, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT).

The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 3 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some implementations, the UE 350 may include a cellular modem (e.g., LTE modem, 5G NR modem, or a combination thereof). The cellular modem may be configured to perform lower layer processing for an LTE radio access technology, a 5G NR standalone radio access technology and/or a 5G NR non-standalone radio access technology. For example, the cellular modem may perform medium access control and physical layer processing on IP packets for wireless transmission to the base station 102/180. In an aspect, when using the cellular modem to access EPC 160 through base station 102/180, the access network may be trusted and tunneling may not be required.

At least one of the TX processor 368, the RX processor 356, and the controller/processor 359 may be configured to perform aspects in connection with cell search component 198 of FIG. 1.

FIG. 4 is a diagram illustrating an example of a PLMN selection procedure in a network environment 400, in accordance with implementations of the present disclosure. As illustrated in FIG. 4, the UE 404 may in communication with a first cell 402-1 and/or a second cell 402-2. In some aspects, the first cell 402-1 may be associated with a first RAT (e.g., 5G NR) and the second cell 402-2 may be associated with a second RAT (e.g., LTE). The UE 104 may include a modem 410 having a service determiner 420, a camping and registration module 430, and a scanning component 440 for performing PLMN searches in a wireless communication system. The scanning component 440 may include an access stratum (AS) layer 450, an acquisition data structure 460, and a non-access stratum (NAS) layer 470. The AS layer 450 may include a PLMN search module 452. The NAS layer 470 may include a PLMN selection module 472. The acquisition data structure 460 may include a RPLMN list 480.

Viewed from perspectives of layered protocol stacks, PLMN selection may generally involve operations from both the AS layer 450 and the NAS layer 470. The AS layer 450 generally refers to protocol stacks between a UE and a radio access network (e.g., a base station), while the NAS layer 470 between a UE and a core network. At a UE 404, the NAS layer 470 may initiate PLMN selection by requesting the AS layer 450 to report a list of available PLMNs (e.g., the RPLMN list 480), from which a RPLMN is to be selected for a subsequent cell selection procedure.

In addition, the PLMN search module 452 also may measure signal quality of a PLMN (that is, of a cell of the PLMN). The signal quality may be based on a measurement metric on a reference signal of a cell of the PLMN. The reference signal may generally refer to any signal transmitted to support cell measurement. An example of a measurement metric may be reference signal received power (RSRP), which may be defined as a linear average of received energy on resource elements of an OFDM symbol carrying a reference signal. Another example of a measurement metric may be reference signal received quality (RSRQ), which may be defined as a ratio between RSRP and an averaged received total power of an OFDM symbol carrying a reference signal. Compared to RSRP, RSRQ may reflect a level of signal to noise and inference ratio with respect to a reference signal.

If a UE 404 measures multiple cells for a same PLMN, the UE 404 may choose a higher (or highest) measurement value to represent the signal quality of the measured PLMN. In some examples, a PLMN whose RSRP is greater than or equal to a threshold (e.g., −110 dBm) may be designated as having “high quality” and reported as such to the NAS layer 470, while a “low quality” PLMN (i.e., not meeting the above “high quality criterion”) may be reported along with its measured signal quality (e.g., RSRP values).

Typically a UE 404 can obtain the (cell-specific) parameters of a cell selection criterion from a system information block (e.g., SIB1) transmitted by a cell. Because in some systems both the PLMN identities and the parameters of cell selection criterion are contained in the same system information block (e.g., SIB1), a UE 404 may read the cell selection criterion parameters along with the PLMN identities during the PLMN search without extra efforts (e.g., by reading both information from a decoded SIB1 from a detected cell). Furthermore, checking whether a cell selection criterion is satisfied (or passed) may not incur significant overhead because the cell selection criterion may reuse measurement metrics already obtained for PLMN selection purposes (e.g., RSRP).

In some aspects, the UE 404 may implement a PLMN selection procedure in the PLMN selection module 472. The PLMN selection module 472 may search and select a RPLMN among available RPLMNs. In particular, the PLMN selection module 472 may select the last registered PLMN, if available, for acquiring a new service to enhance the PLMN selection procedure, for example, to avoid selecting a PLMN whose cells may fail a cell selection procedure.

After a RPLMN is selected, the PLMN selection module 472 may select a cell of the selected RPLMN for services, such as camping, registration, or communication. Generally, during a cell selection procedure, a UE 404 attempts to find and select a “suitable” cell which meets certain conditions and/or preferences, such as satisfying a cell selection criterion in terms of signal quality, belonging to a selected PLMN (or the registered PLMN or an equivalent PLMN), being not barred, and belonging to at least one tracking area that is not forbidden, and so on. The PLMN selection module 472 may not require any prior knowledge for purposes of PLMN selection and may scan all radio frequency channels for a suitable cell. Nevertheless, prior knowledge regarding PLMN may facilitate PLMN selection, and in particular, as the PLMN selection module 472 acquires registration information on last registered PLMNs for a particular RAT, the PLMN selection module 472 may leverage such information during PLMN selection, e.g., to improve efficiency, enhance user experience, and reduce time/computation cost.

A UE 404 may maintain the acquisition data structure 460 for storing and retrieving information regarding a RPLMN. The PLMN selection module 472 may update the acquisition data structure 460 with new or latest registration information obtained during the PLMN selection procedure, for example, after a PLMN is registered. In some aspects, the acquisition data structure 460 may retain a variety of information on cells and PLMNs, such as frequency carrier, physical cell identity, frequency band, energy measurement, and so on. If system information of a cell is read during the PLMN search, some or all part of the system information can be stored in the acquisition data structure 460.

In some aspects, the scanning component 440 may store the registered PLMNs in the acquisition data structure 460. For example, the scanning component 440 may store a RAT identifier along with an associated RPLMN identifier based on a determination that a PLMN was successfully registered for acquiring a service associated with a particular RAT. In an aspect, the scanning component 440 may store the RPLMN of a particular RAT in a chronological order with the one or more RPLMNs in the acquisition data structure 460.

The information stored in the acquisition data structure 460 may facilitate operations of PLMN selection in various ways. For example, parameters of a PLMN selection criterion, may be stored in the acquisition data structure 460. These parameters may be readily obtainable when the UE 404 attempts to decode a broadcast channel for PLMN identity information (e.g., in SIB1) of a cell. For example, a new (or subsequent) PLMN selection may reuse information gathered during a previous PLMN selection for checking cell selection criterion, identifying a cell of a previously detected PLMN, and so on. During a subsequent PLMN selection procedure, the PLMN selection module 472 may use or reuse the (cached) parameters for checking the PLMN selection criterion, without decoding a cell's broadcast channel again, which can help to reduce the time/computation expended for checking the PLMN selection criterion.

In an aspect, the acquisition data structure 460 may be a data store, a non-volatile memory, or some other component suitable for storing data, configured to store information related to RPLMN-RAT combinations that are most likely to yield service acquisition for UE 404 with less delay. In some aspects, the acquisition data structure 460 may be a smart card, such as a universal integrated circuit card (UICC), that is either permanently or non-permanently, coupled to the UE 404. In some aspects, the UE 404 may remove (or erase) the RPLMN identities from storage when the smart card is removed from the UE 404. In an aspect, the RPLMN-RAT combinations within the acquisition data structure 460 may be preconfigured by one or more users of the UE 404, one or more wireless service providers associated with the UE 404, a manufacturer of the UE 404, a network operator, or the like. In an aspect, the RPLMN-RAT combinations within the acquisition data structure 460 may be dynamically adjusted, updated, and/or changed by one or more users of the UE 404, one or more wireless service providers associated with the UE 404, a manufacturer of the UE 404, a network operator, or the like.

In an aspect, the acquisition data structure 460 stores the RPLMN list 480 that includes RPLMN-RAT combinations as a chart, list, or other correlated data format, which includes entries. An entry may include a RPLMN identifier (ID), which may be, for example, an indication of a wireless service provider associated with a PLMN (e.g., Wireless Carrier A, Wireless Carrier B, or the like) and/or an indication as to whether a PLMN is the Registered PLMN (RPLMN), a home PLMN (HPLMN) with which the UE 404 is associated, or a visited PLMN (VPLMN). An entry also may include a RAT, which may be, for example, 5G NR SA, 5G NR NSA, LTE SA, GSM, UMTS, or the like, a frequency, which may be listed in megahertz (MHz) or gigahertz (GHz), and additional information or other details related to the RPLMN-RAT combination of the particular entry. The other details for each entry may include, in a non-limiting example, one or more of a time stamp information (e.g., when an entry was added to acquisition data structure 460, when the RPLMN-RAT combination was identified, or the like), further identifying information for any of the RPLMN, RAT, or frequency in the entry, and/or any information related to acquiring service according to the RPLMN-RAT combination.

In some aspects, the RPLMN list 480 includes one or more RPLMN identities (e.g., 461, 464, 467, etc.) corresponding to the second RAT 168. Furthermore, each of the one or more RPLMN identities in the acquisition data structure 460 is associated with a RAT (e.g., 462, 465, 468, etc.). For example, the scanning component 440 may store a RPLMN identity 461 (e.g., depicted as “RPLMN₁”) associated with a first RAT identity 462 (e.g., depicted as “RAT₁”) in a prioritized order with the one or more RPLMN identities in the RPLMN list 480 stored within the acquisition data structure 460. In other instances, the scanning component 440 may store a RPLMN identity 464 (depicted as “RPLMN₂”) of associated with a second RAT identity 465 (depicted as “RAT₂”) in a variety of different manners with the one or more RPLMN-RAT combinations in the RPLMN list 480.

At the AS layer 450, to generate the RPLMN list 480, a PLMN search module 452 may scan a number of frequency channels within supported frequency bands for potential cells/PLMNs. As illustrated in this example, a UE 404 may receive signals from multiple cells (e.g., corresponding to multiple base stations 402-1, 402-2), based on which the UE 404 may detect the presence of one or more cells, measure signal quality of the cells, obtain system information from the cells (e.g., by decoding one or more broadcast channels of the cells), and so on. In some implementations, a UE 404 may read a list of PLMN identities, e.g., MCCs/MNCs, from a system information block transmitted by a cell; for example, system information block 1 (SIB1) in 5G NR (transmitted in a broadcast channel) may contain identities of one or more PLMNs to which the cell belongs (i.e., the same cell can be shared by multiple PLMNs). Having detected a cell, a UE 404 may identify the associated PLMNs. In some aspects, a UE 404 may read a list of PLMNs from the strongest cell on each carrier. The UE 404 may initiate a registration procedure with the cell, such that the UE 404 may successfully register a PLMN as a new RPLMN. The new RPLMN may be added to the RPLMN list 480 as the search progresses.

As illustrated in FIG. 4, the UE 404 includes the service determiner 420, which may be configured to determine that the UE 404 is currently in an out-of-service state as a result of detecting that UE 404 was recently powered on and/or is otherwise without service. If so, then the service determiner 420 may communicate an out of service or no service indication 422 to the scanning component 440 to request performing a scan for service. In an additional aspect, the service determiner 420 may also be configured to determine a PLMN to which UE 404 was most recently registered, e.g., an RPLMN (e.g., RPLMNs 461, 464, 467, etc.) and/or a RAT (e.g., RATs 462, 465, 468, etc.) on which the UE 404 was most recently camped. In an aspect, the identity of a most recently registered RPLMN and the identity of the most recent RAT may be communicated to the scanning component 440 as part of the out of service indication 422. In an additional aspect, the identity of the RPLMN and the identity of the most recent RAT may be determined by another component or components and communicated to the scanning component 440 in some other fashion.

In an aspect, the UE 404 includes the scanning component 440 configured to scan for service at the UE 404. The PLMN search module 452 may be configured to receive the out of service indication 422 from the service determiner 420, which may, in an aspect, include the identity of a last registered RPLMN and/or identity of a most recent RAT. In response, the scanning component 440 may be configured to activate the PLMN search module 452 to begin scanning at a first frequency associated with the last registered RPLMN and/or the most recent RAT. To do so, the PLMN search module 452 may be configured to communicate with the acquisition data structure 460 to retrieve a first frequency, which may be communicated as one or more RPLMN-RAT combinations from the RPLMN list 480. From the RPLMN-RAT combination(s), the PLMN search module 452 may be configured to select the first frequency for scanning associated with the most recently registered RPLMN based on, for example, a priority system, a predetermined order, a dynamically changeable order, a user-defined order, and/or any other method.

In some aspects, the scanning component 440, through coordination with the PLMN search module 452 and/or the PLMN selection module 472, may rank (or prioritize) the stored RPLMNs according to their respective RATs. In this regard, the RAT may have an associated priority such that one RAT may be preferable (or have a higher priority) over another RAT. In some aspects, the priorities may be assigned to each specific RAT based on a downlink configuration and/or a UE capability negotiation with the network. In some aspects, the scanning component 440 may rank one or more suitable cells based on one or more cell measurement parameters of each of the one or more suitable cells. Further, the scanning component 440 may select a suitable cell associated with a highest ranked RPLMN, such that the UE 404 may camp and/or connect to the cell to acquire a requested service associated with the highest ranked RPLMN.

In an aspect, the PLMN search module 452 may be configured to scan a first frequency associated with the last registered RPLMN and/or the most recent RAT. For example, the last registered RPLMN may be the RPLMN the UE previously camped on prior to entering the OOS state. If PLMN search module 452 determines that service was not acquired based on scanning the first frequency because, for example, the UE did not identify a signal on which service may be acquired associated with the first frequency associated with the last registered RPLMN, the PLMN search module 452 may be configured to scan for a second frequency, still associated with the last registered RPLMN. To do so, the PLMN selection module 472 may, in an aspect, be configured to refer to RPLMN-RAT combination(s) if more than one frequency for the last registered RPLMN were provided therein. In another aspect, the PLMN selection module 472 may be configured to communicate with the acquisition data structure 460 to retrieve, through coordination with the PLMN search module 452, another RPLMN-RAT combination such that it may select a second frequency associated with the last registered RPLMN. The PLMN search module 452 may be configured to continue this process until it either identifies a signal on which service may be acquired, or it exhausts all frequencies of the last registered RPLMN.

In an aspect, the UE 404 includes the camping and registration module 430 configured to receive scan result 424 and attempt to register the UE 404 with the RPLMN. If the scan result 424 includes an indication that a signal on which service may be acquired was identified by the PLMN search module 452, the camping and registration module 430 may be configured to camp on and attempt to register with the RPLMN. If the scan result 424 includes an indication that the PLMN search module 452 completed scanning all frequencies for a RAT associated with the last registered RPLMN, and no frequencies for camping are found, the camping and registration module 430 may be configured to send a list of available PLMNs to the NAS layer 470 when the scanning component 440 determines that at least one frequency associated with the last registered RPLMN is not found during the scanning of one or more frequencies of the last registered RPLMN based on the acquisition data structure 460.

In an additional aspect, the NAS layer 470 may send a request to a radio resource of the UE 404 to switch to a different RAT (e.g., from 5G NR to LTE only) and to scan frequencies of the target RAT for service. For example, the scanning component 440 may be configured to switch the UE 404 from one RAT (e.g., most recent RAT) to the target RAT as the UE 404 is a multi-mode UE that is capable of supporting multiple RATs for acquiring service.

In an aspect, some or all of the functions described with respect to the service determiner 420, the camping and registration module 430, may be part of the NAS layer 470 of the scanning component 440. In an aspect, some or all of the functions described with respect to the camping and registration module 430, the scanning component 440, and/or the acquisition data structure 460 may be part of a lower layer radio resource (e.g., an RRC layer), depending on the implemented RAT.

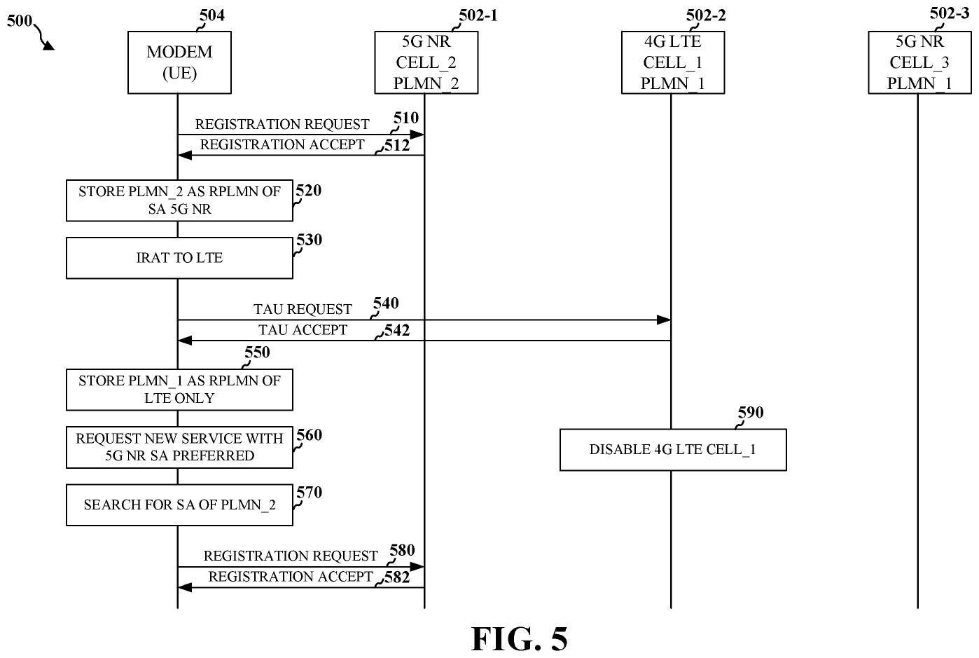

FIG. 5 is a diagram illustration a communication flow for RPLMN selection and registration in accordance with some aspects of the present disclosure. As illustrated in FIG. 5, a UE 504 communicates with a first base station 502-1 associated with a first RAT (e.g., 5G NR). The first base station 502-1 may belong to a first PLMN (depicted as “PLMN_2”) and may be identified as a cell (depicted as “Cell_2”) of PLMN_2. In some aspects, the UE 504 communicates with a second base station 502-2 associated with a second RAT (e.g., LTE). The second base station 502-2 may belong to a second PLMN (depicted as “PLMN_1”) and may be identified as a first cell (depicted as “Cell_1”) of PLMN_1. In some aspects, the UE 504 may communicate with a third base station 502-3 associated with a third RAT (e.g., 5G NSA). The third base station 502-3 may belong to the second PLMN (depicted as “PLMN_1”) and may be identified as a second cell (depicted as “Cell_3”) of PLMN_1.

At 510, the UE 504 sends a registration request message to the base station 502-1 (e.g., depicted as “Cell_2”) associated with the 5G NR standalone access technology. At 512, the base station 502-1 sends a registration acceptance message to the UE 504.

At 520, the UE 504 stores the PLMN identity of a second PLMN (e.g., depicted as “PLMN_2”) that contains the base station 502-1 as a first registered PLMN of the 5G NR standalone access technology. In this regard, the UE 504 may store the first RPLMN in memory (e.g., in the acquisition data structure 460 in FIG. 4). In some aspects, the UE 504 may search for a specified RAT by determining which RPLMN in memory (e.g., in the acquisition data structure 460) corresponds to the specified RAT. By doing so, the UE 504 may reduce the amount of delay in searching for a PLMN that supports the preferred RAT for the requested service. In some aspects, the UE 504 may store the RPLMN in local memory, such as in non-volatile memory. In some aspects, the UE 504 may store the RPLMN in a smart card (e.g., universal integrated circuit card (UICC)), that is either permanently or non-permanently, coupled to the UE 504. In some aspects, the UE 504 may remove the RPLMN from storage when the smart card is removed from the UE 504.

At 530, the UE 504 may receive a request from the network to perform an inter-RAT transition from a first RAT (e.g., the 5G NR standalone system) to a second RAT (e.g., LTE only). At 540, the UE 504 may send a tracking area update message to the base station 502-2 (e.g., depicted as “Cell_1”) associated with the LTE standalone access technology. At 542, the base station 502-2 may send a tracking area update acceptance message to the UE 504.

At 550, the UE 504 stores the PLMN identity of a first PLMN (e.g., depicted as “PLMN_1”) that contains the base station 502-1 as a second registered PLMN of the LTE standalone access technology. In this regard, the UE 504 also may store the second RPLMN in memory (e.g., in the acquisition data structure 460 in FIG. 4).

At 560, the UE 504 may request a new service with a preferred RAT, such as 5G NR SA. In prior approaches, the NAS layer of the UE 504 (e.g., the NAS layer 470 in FIG. 4) may request to search the first PLMN (e.g., PLMN_1) by default, for which a PLMN search may not yield any favorable results based on the fact that PLMN_1 has been registered to support the LTE-only RAT. Rather than searching for a specified RAT based on a default PLMN, the UE 504 may initiate the PLMN search using the last registered PLMN (or RPLMN) of that specified RAT. In this example, the last registered PLMN for NR SA is PLMN_2, not PLMN_1. By initiating the PLMN search for PLMN_2, the registration with the cell operating in the PLMN_2 is more likely to be successfully completed and, thereby, decrease any latency in the camping and registration procedure on the specified RAT. In some aspects, at 590, the base station 502-2 associated with the LTE-only system may be disabled based on the UE 504 requesting service associated with the specified RAT as 5G NR standalone, of which any communications to acquire the requested service are to be directed to the base station 502-1 as it is contained within the PLMN that supports the specified RAT (e.g., PLMN_2).

At 570, the UE 504 searches for the specified RAT (e.g., 5G NR standalone system) of a PLMN (e.g., PLMN_2) associated with the specified RPLMN from the acquisition data structure 460. At 580, the UE 504 sends a registration request message to the base station 502-1 associated with the 5G NR standalone access technology based on the PLMN search by the UE 504 using the last registered RPLMN of the specified RAT. At 582, the base station 502-1 sends a registration acceptance message to the UE 504. The 504 may thereafter establish a connection with the base station 502-1 to acquire the requested service associated with the specified RAT.

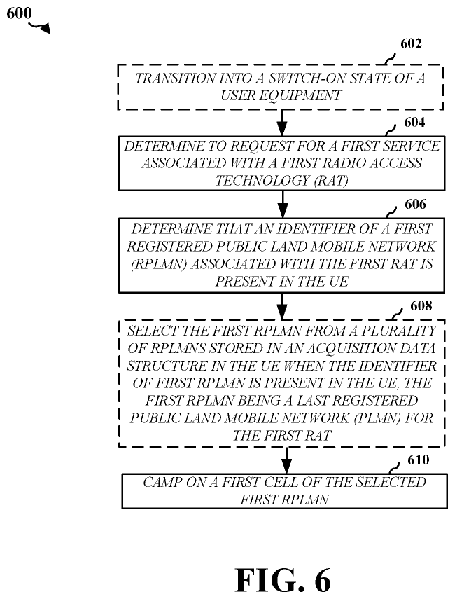

FIG. 6 is a flowchart illustrating an example process 600 of wireless communication that supports improvements to PLMN search at switch-on in accordance with some aspects of the present disclosure. The process may be performed by a UE (e.g., UE 104, 350, 404, 504; the apparatus 702; the processing system 814, which may include the memory 360 and which may be the entire UE 350 or a component of the UE 350, such as the TX processor 368, the RX processor 356, and/or the controller/processor 359). Optional aspects are illustrated in dashed lines.

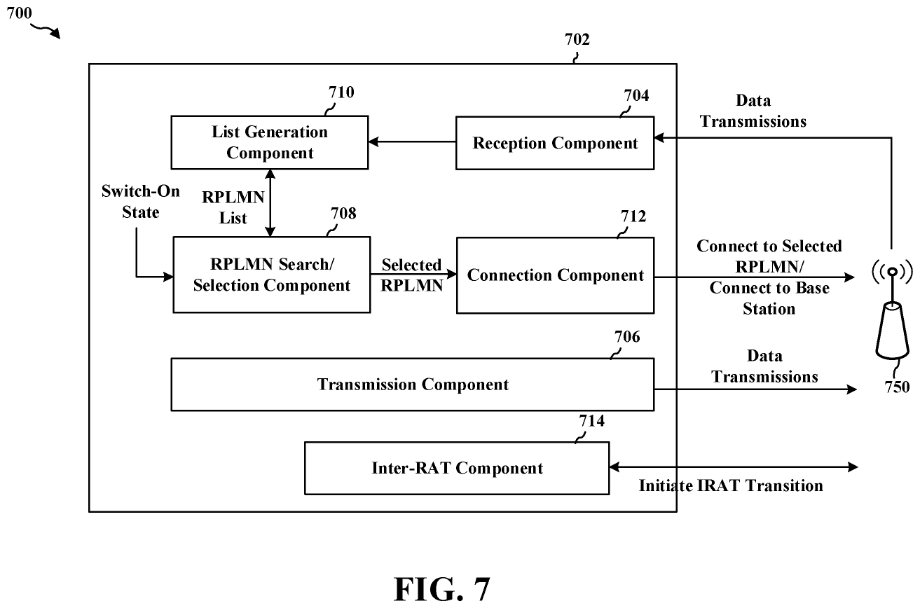

At 602, the UE may detect a transition into a switch-on state of the UE. For example, 602 may be performed by RPLMN search/selection component 708 of FIG. 7. In the context of FIGS. 1 and 3, for example, the UE 104/350 may use a modem processor and/or its cellular modem to detect the transition into a switch-on state of the UE.

At 604, the UE may determine to request for a first service associated with a first radio access technology. For example, 604 may be performed by list generation component 710 of FIG. 7. In the context of FIGS. 1 and 3, for example, the UE 104/350 may use a modem processor and/or its cellular modem to determine to request for the first service associated with the first RAT (e.g., 5G NR SA). In some aspects, the UE may receive, from a non-stratum access layer of the UE, a request to access the first RAT for the first service. In some aspects, the UE may select the first RPLMN from a plurality of RPLMNs stored in an acquisition data structure in the UE when the identifier of first RPLMN is present in the UE. In some aspects, the first RPLMN is a last registered public land mobile network for the first RAT.

At 606, the UE may determine that an identifier of a first registered public land mobile network associated with the first RAT is present in the UE. For example, 606 may be performed by RPLMN search/selection component 708 of FIG. 7. In the context of FIGS. 1 and 3, for example, the UE 104/350 may use a modem processor and/or its cellular modem to search for a previously-stored RPMLN identity in memory by searching for the RPLMN identity within an acquisition data structure in the UE. In some aspects, the RPLMN search/selection component 708 may utilize the RPLMN list obtained from the list generation component 710. Alternatively, in some aspects, the UE may perform a cell search in a first public land mobile network when the last registered RPLMN identity associated with the first RAT is not present in the UE. The UE may select the first cell of the first PLMN for camping based on the cell search. The UE may transmit, to the first cell, a first request for registering the UE to the first PLMN. In turn, the UE may receive, from the first cell, a first response based on the first request, in which the first response indicates a registration acceptance to register the UE to the first PLMN. The UE can then store the first PLMN as the first RPLMN for the first RAT based on the registration acceptance.

At 608, the UE may select the first RPLMN from a plurality of RPLMNs stored in the acquisition data structure in the UE when the identifier of first RPLMN is present in the UE. In some aspects, the first RPLMN is a last registered PLMN for the first RAT. For example, 608 may be performed by the RPLMN search/selection component 708 of FIG. 7. In the context of FIGS. 1 and 3, for example, the UE 104/350 may use a modem processor and/or its cellular modem to select the first RPLMN from the acquisition data structure. In some aspects, the UE may obtain the identifier of the first RPLMN from an acquisition data structure in the UE. For example, the UE may obtain the RPLMN identity from a UICC in the UE. The UE may select the first cell of the first RPLMN in a first cell search.

At 610, the UE may camp on a first cell of the first RPLMN when the identifier of the first RPLMN is present in the UE. For example, 610 may be performed by the RPLMN search/selection component 708, through coordination with the connection component 712 of FIG. 7. In the context of FIGS. 1 and 3, for example, the UE 104/350 may use a modem processor and/or its cellular modem to camp on the first cell. In some aspects, the UE may transmit, to the first cell, a first request for registering the UE to the first RPLMN. The UE may receive, from the first cell, a response to the first request. In some aspects, the response indicates acceptance of the first request for registering the UE to the first RPLMN.

In some aspects, the UE may detect an inter-radio access technology transition from the first RAT to a second RAT different than the first RAT. For example, the UE may detect an inter-RAT from 5G SA to LTE-only. The UE may determine whether an identifier of a second RPLMN associated with the second RAT is present in the UE. In some aspects, the UE may perform a cell search in a second public land mobile network when the last registered RPLMN identity associated with the second RAT is not present in the UE. In this regard, the UE may select a second cell of the second PLMN for camping based on the cell search. In some aspects, the UE may store a second PLMN as the second RPLMN for the second RAT when the identifier of the second RPLMN is not present in the UE. In some aspects, the second RAT corresponds to a standalone LTE access technology. In other aspects, the second RAT corresponds to a non-standalone 5G NR access technology.

In some aspects, the UE may obtain the identifier of the second RPLMN associated with the second RAT from the acquisition data structure in the UE. The UE may select a second cell of the second RPLMN in a second cell search. The UE may thereafter communicate, with the second cell, tracking area update information. The second cell may utilize the TAU information for registering the UE to the second RPLMN. For example, the UE may transmit, to the second cell, a second request for registering the UE to the second PLMN. The UE may receive, from the second cell, a second response based on the second request. In some aspects, the second response may indicate acceptance of a tracking area update in the second request. As such, the UE may store the second PLMN as the second RPLMN for the second RAT based on the acceptance of the tracking area update.

FIG. 7 is a conceptual data flow diagram 700 illustrating the data flow between different means/components in an example apparatus 702. The apparatus 702 may be a UE or a component of a UE (e.g., such as UE 104, 350). The apparatus 702 may include a reception component 704, a transmission component 706, a RPLMN search/selection component 708, a list generation component 710, a connection component 712 and an inter-RAT component 714.

The reception component 704 may be configured to receive signals and/or other information from other devices including, e.g., base station 750. The signals/information received by the reception component 704 may be provided to one or more components of the apparatus 702 for further processing and use in performing various operations in accordance with the methods discussed supra including the process 600 of the flowchart in FIG. 6. Thus, via the reception component 704, the apparatus 702 and/or one or more components therein receive signals and/or other information (e.g., such as data for the apparatus 702 and/or other control signaling) from the base station 750 as discussed supra and also discussed more specifically infra. The reception component 704 may be configured to receive, from a first cell associated with a first RAT, a first response based on a first request, in which the first response indicates a registration acceptance to register the UE to a first PLMN of the first RAT. As such, the UE may store the first PLMN as a first RPLMN for the first RAT based on the registration acceptance. The reception component 704 also may be configured to receive, from a second cell associated with a second RAT, a second response based on a second request. In some aspects, the second response may indicate acceptance of a tracking area update in the second request. As such, the UE may store the second PLMN as a second RPLMN for the second RAT based on the acceptance of the tracking area update.

The transmission component 706 may be configured to transmit various messages to one or more external devices, e.g., including the base station 750, in accordance with the methods disclosed herein. The messages/signals to be transmitted may be generated by one or more other components as discussed above, or the messages/signals to be transmitted may be generated by the transmission component 706 under the direction/control of the one or more other components discussed supra. Thus, in various configurations, via the transmission component 706, the apparatus 702 and/or one or more components therein transmit signals and/or other information (e.g., such as data, selected PLMN information, control messages and/or other signals) to external devices such as the base station 750. In some aspects, the transmission component 706 may be configured to transmit, to a first cell associated with a first RAT, a first request for registering the UE to a first RPLMN of the first RAT. In some aspects, the transmission component 706 may be configured to transmit, to a second cell associated with a second RAT, a second request for registering the UE to a second PLMN of the second RAT.

The RPLMN search/selection component 708 may be configured to detect a transition into a switch-on state of the UE, e.g., as described in connection with block 602 of FIG. 6. The RPLMN search/selection component 708 may be configured to determine that an identifier of a first registered public land mobile network associated with the first RAT is present in the UE, e.g., as described in connection with block 606 of FIG. 6. The RPLMN search/selection component 708 may be configured to select the first RPLMN from a plurality of RPLMNs stored in the acquisition data structure in the UE when the identifier of first RPLMN is present in the UE, e.g., as described in connection with block 608 of FIG. 6. The RPLMN search/selection component 708 may be configured to camp on a first cell of the first RPLMN when the identifier of the first RPLMN is present in the UE, e.g., as described in connection with block 610 of FIG. 6. In some aspects, the RPLMN search/selection component 708 may obtain the identifier of the first RPLMN from an acquisition data structure in the UE. In other aspects, the RPLMN search/selection component 708 may obtain the identifier of the second RPLMN associated with the second RAT from an acquisition data structure in the UE.

The list generation component 710 may be configured to determine to request for a first service associated with a first radio access technology, e.g., as described in connection with block 604 of FIG. 6. In some aspects, the list generation component 710 may be configured to generate the RPLMN list (e.g., 462) stored in the acquisition data structure (e.g., 460 in FIG. 4).

The connection component 712 may be configured to camp on a first cell of the first RPLMN, through coordination with the RPLMN search/selection component 708, when the identifier of the first RPLMN is present in the UE.

The inter-RAT component 714 may be configured to initiate an inter-radio access technology transition from the first RAT to a second RAT different than the first RAT. In this regard, the inter-RAT component 714 may communicate with the base station 750 to initiate the inter-RAT transition. For example, the UE may transition from the 5G NR SA to 4G LTE only. In other aspects, the inter-RAT component 714 may be configured to detect the inter-RAT transition from the first RAT to the second RAT.

The apparatus 702 may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

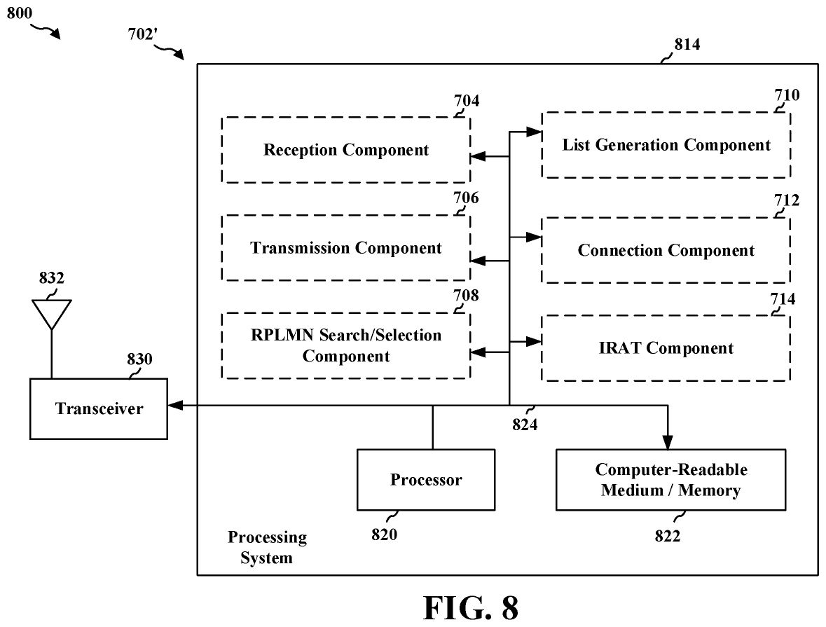

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714 and the computer-readable medium/memory 822. The bus 824 may also link various other circuits such as timing sources, peripherals, voltage regulators, and power management circuits, which are well known in the art, and therefore, will not be described any further.

The processing system 814 may be coupled to a transceiver 830. The transceiver 830 is coupled to one or more antennas 832. The transceiver 830 provides a means for communicating with various other apparatus over a transmission medium. The transceiver 830 receives a signal from the one or more antennas 832, extracts information from the received signal, and provides the extracted information to the processing system 814, specifically the reception component 704. In addition, the transceiver 830 receives information from the processing system 814, specifically the transmission component 706, and based on the received information, generates a signal to be applied to the one or more antennas 832. The processing system 814 includes a processor 820 coupled to a computer-readable medium/memory 822. The processor 820 is responsible for general processing, including the execution of software stored on the computer-readable medium/memory 822. The software, when executed by the processor 820, causes the processing system 814 to perform the various functions described supra for any particular apparatus. The computer-readable medium/memory 822 may also be used for storing data that is manipulated by the processor 820 when executing software. The processing system 814 further includes at least one of the components 704, 706, 708, 710, 712, 714. The components may be software components running in the processor 820, resident/stored in the computer-readable medium/memory 822, one or more hardware components coupled to the processor 820, or some combination thereof. The processing system 814 may be a component of the UE 350 and may include the memory 360 and/or at least one of the TX processor 368, the RX processor 356, and the controller/processor 359. Alternatively, the processing system 814 may be the entire UE (e.g., see 350 of FIG. 3).

In one configuration, the apparatus 702/702′ is a UE for wireless communication including means for performing the aspects described in connection with FIGS. 4-6. For example, in one configuration, the UE may comprise means for determining to request for a first service associated with a first radio access technology. In one configuration, the UE may further comprise means for determining whether an identifier of a first registered public land mobile network associated with the first RAT is present in the UE. In one configuration, the UE may further comprise means for camping on a first cell of the first RPLMN when the identifier of the first RPLMN is present in the UE.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The following examples are illustrative only and may be combined with aspects of other embodiments or teachings described herein, without limitation.

Aspect 1 is a method of wireless communication at a user equipment that includes determining to request for a first service associated with a first radio access technology; determining whether an identifier of a first registered public land mobile network associated with the first RAT is present in the UE; and camping on a first cell of the first RPLMN when the identifier of the first RPLMN is present in the UE.

In Aspect 2, the method of Aspect 1 further includes transitioning into a switch-on state of the UE, and wherein the determining to request for the first service comprises receiving, from a non-stratum access layer of the UE, a request to access the first RAT for the first service, wherein the determining whether the identifier of the first RPLMN associated with the first RAT is present comprises selecting the first RPLMN from a plurality of RPLMNs stored in an acquisition data structure in the UE when the identifier of first RPLMN is present in the UE, the first RPLMN being a last registered public land mobile network for the first RAT.

In Aspect 3, the method of Aspect 1 or Aspect 2 further includes obtaining the identifier of the first RPLMN from an acquisition data structure in the UE; selecting the first cell of the first RPLMN in a first cell search; transmitting, to the first cell, a first request for registering the UE to the first RPLMN; and receiving, from the first cell, a response to the first request, the response indicating acceptance of the first request for registering the UE to the first RPLMN.

In Aspect 4, the method of any of Aspects 1-3 further includes detecting a transition into a switch-on state of the UE, wherein the determining whether an identifier of a first RPLMN associated with the first RAT is present in the UE comprises determining whether a last registered RPLMN identity associated with the first RAT is present in the UE; performing a cell search in a first public land mobile network when the last registered RPLMN identity associated with the first RAT is not present in the UE; selecting the first cell of the first PLMN for camping based on the cell search; transmitting, to the first cell, a first request for registering the UE to the first PLMN; receiving, from the first cell, a first response based on the first request, the first response indicating a registration acceptance to register the UE to the first PLMN; and storing the first PLMN as the first RPLMN for the first RAT based on the registration acceptance.

In Aspect 5, the method of any of Aspects 1-4 further includes detecting a transition into an out-of-service state of the UE; accessing an acquisition data structure that comprises one or more RPLMN identities associated with respective ones of a plurality of RATs; determining whether the acquisition data structure includes at least one RPLMN identity in the one or more RPLMN identities that is associated with the first RAT; and selecting the first cell of the first RPLMN when the acquisition data structure includes the at least one RPLMN identity that is associated with the first RAT.

In Aspect 6, the method of any of Aspects 1-5 further includes that the first RAT corresponds to a standalone 5G NR access technology.

In Aspect 7, the method of any of Aspects 1-6 further includes detecting an inter-radio access technology transition from the first RAT to a second RAT different than the first RAT; determining whether an identifier of a second RPLMN associated with the second RAT is present in the UE; and storing a second PLMN as the second RPLMN for the second RAT when the identifier of the second RPLMN is not present in the UE.

In Aspect 8, the method of any of Aspects 1-7 further includes obtaining the identifier of the second RPLMN associated with the second RAT from an acquisition data structure in the UE; selecting a second cell of the second RPLMN in a second cell search; and communicating, with the second cell, tracking area update information.

In Aspect 9, the method of any of Aspects 1-8 further includes performing an inter-radio access technology transition from the first RAT to a second RAT different than the first RAT; determining whether a last registered RPLMN identity associated with the second RAT is present in the UE; performing a cell search in a second public land mobile network when the last registered RPLMN identity associated with the second RAT is not present in the UE; selecting a second cell of the second PLMN for camping based on the cell search; transmitting, to the second cell, a second request for registering the UE to the second PLMN; receiving, from the second cell, a second response based on the second request, the second response indicating acceptance of a tracking area update in the second request; and storing the second PLMN as the second RPLMN for the second RAT based on the acceptance of the tracking area update.

In Aspect 10, the method of any of Aspects 1-9 further includes that the second RAT corresponds to a standalone LTE access technology.

In Aspect 11, the method of any of Aspects 1-9 further includes that the second RAT corresponds to a non-standalone 5G NR access technology.

Aspect 12 is a device including one or more processors and one or more memories in electronic communication with the one or more processors storing instructions executable by the one or more processors to cause a system or an apparatus to implement a method as in any of Aspects 1 to 11.

Aspect 13 is a system or apparatus including means for implementing a method or realizing an apparatus as in any of Aspects 1 to 11.

Aspect 14 is a non-transitory computer-readable medium storing instructions executable by one or more processors to cause the one or more processors to implement a method as in any of Aspects 1 to 11.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), the method comprising:
determining to request for a first service associated with a first radio access technology (RAT);
determining whether an identifier of a first registered public land mobile network (RPLMN) associated with the first RAT is present in the UE; and
camping on a first cell of the first RPLMN when the identifier of the first RPLMN is present in the UE.

2. The method of claim 1, further comprising transitioning into a switch-on state of the UE, and
wherein the determining to request for the first service comprises receiving, from a non-stratum access (NAS) layer of the UE, a request to access the first RAT for the first service,
wherein the determining whether the identifier of the first RPLMN associated with the first RAT is present comprises selecting the first RPLMN from a plurality of RPLMNs stored in an acquisition data structure in the UE when the identifier of first RPLMN is present in the UE, the first RPLMN being a last registered public land mobile network (PLMN) for the first RAT.

3. The method of claim 1, further comprising:
obtaining the identifier of the first RPLMN from an acquisition data structure in the UE;
selecting the first cell of the first RPLMN in a first cell search;
transmitting, to the first cell, a first request for registering the UE to the first RPLMN; and
receiving, from the first cell, a response to the first request, the response indicating acceptance of the first request for registering the UE to the first RPLMN.

4. The method of claim 1, further comprising:
detecting a transition into a switch-on state of the UE,
wherein the determining whether an identifier of a first RPLMN associated with the first RAT is present in the UE comprises determining whether a last registered RPLMN identity associated with the first RAT is present in the UE;
performing a cell search in a first public land mobile network (PLMN) when the last registered RPLMN identity associated with the first RAT is not present in the UE;
selecting the first cell of the first PLMN for camping based on the cell search;
transmitting, to the first cell, a first request for registering the UE to the first PLMN;
receiving, from the first cell, a first response based on the first request, the first response indicating a registration acceptance to register the UE to the first PLMN; and
storing the first PLMN as the first RPLMN for the first RAT based on the registration acceptance.

5. The method of claim 1, further comprising:
detecting a transition into an out-of-service state of the UE;
accessing an acquisition data structure that comprises one or more RPLMN identities associated with respective ones of a plurality of RATs;
determining whether the acquisition data structure includes at least one RPLMN identity in the one or more RPLMN identities that is associated with the first RAT; and
selecting the first cell of the first RPLMN when the acquisition data structure includes the at least one RPLMN identity that is associated with the first RAT.

6. The method of claim 1, wherein the first RAT corresponds to a standalone Fifth Generation (5G) New Radio (NR) access technology.

7. The method of claim 1, further comprising:
detecting an inter-radio access technology (IRAT) transition from the first RAT to a second RAT different than the first RAT;
determining whether an identifier of a second RPLMN associated with the second RAT is present in the UE; and
storing a second PLMN as the second RPLMN for the second RAT when the identifier of the second RPLMN is not present in the UE.

8. The method of claim 7, further comprising:
obtaining the identifier of the second RPLMN associated with the second RAT from an acquisition data structure in the UE;
selecting a second cell of the second RPLMN in a second cell search; and
communicating, with the second cell, tracking area update (TAU) information.

9. The method of claim 1, further comprising:
performing an inter-radio access technology (IRAT) transition from the first RAT to a second RAT different than the first RAT;
determining whether a last registered RPLMN identity associated with the second RAT is present in the UE;
performing a cell search in a second public land mobile network (PLMN) when the last registered RPLMN identity associated with the second RAT is not present in the UE;
selecting a second cell of the second PLMN for camping based on the cell search;
transmitting, to the second cell, a second request for registering the UE to the second PLMN;
receiving, from the second cell, a second response based on the second request, the second response indicating acceptance of a tracking area update in the second request; and
storing the second PLMN as the second RPLMN for the second RAT based on the acceptance of the tracking area update.

10. The method of claim 7, wherein the second RAT corresponds to a standalone Long-Term Evolution (LTE) access technology.

11. The method of claim 7, wherein the second RAT corresponds to a non-standalone Fifth Generation (5G) New Radio (NR) access technology.

12. An apparatus for wireless communication at a user equipment (UE), comprising:
at least one processor; and
a memory coupled to the at least one processor and storing computer-executable code, which when executed by the at least one processor, causes the apparatus to:
determine to request for a first service associated with a first radio access technology (RAT);
determine whether an identifier of a first registered public land mobile network (RPLMN) associated with the first RAT is present in the UE; and
camp on a first cell of the first RPLMN when the identifier of the first RPLMN is present in the UE.

13. The apparatus of claim 12, wherein:
the code, which when executed by the at least one processor, further causes the apparatus to transition into a switch-on state of the UE,
the determination to request for the first service comprises to receive, from a non-stratum access (NAS) layer of the UE, a request to access the first RAT for the first service, and
the determination of whether the identifier of the first RPLMN associated with the first RAT is present comprises to select the first RPLMN from a plurality of RPLMNs stored in an acquisition data structure in the UE when the identifier of first RPLMN is present in the UE, the first RPLMN being a last registered public land mobile network (PLMN) for the first RAT.

14. The apparatus of claim 12, wherein the code, which when executed by the at least one processor, further causes the apparatus to:
obtain the identifier of the first RPLMN from an acquisition data structure in the UE;
select the first cell of the first RPLMN in a first cell search;
transmit, to the first cell, a first request for registering the UE to the first RPLMN; and
receive, from the first cell, a response to the first request, the response indicating acceptance of the first request for registering the UE to the first RPLMN.

15. The apparatus of claim 12, wherein the code, which when executed by the at least one processor, further causes the apparatus to:
transition into a switch-on state;
determine whether a last registered RPLMN identity associated with the first RAT is present in the UE;
perform a cell search in a first public land mobile network (PLMN) when the last registered RPLMN identity associated with the first RAT is not present in the UE;
select the first cell of the first PLMN for camping based on the cell search;
transmit, to the first cell, a first request for registering the UE to the first PLMN;
receive, from the first cell, a first response based on the first request, the first response indicating a registration acceptance to register the UE to the first PLMN; and
store the first PLMN as the first RPLMN for the first RAT based on the registration acceptance.

16. The apparatus of claim 12, wherein the code, which when executed by the at least one processor, further causes the apparatus to:
detect a transition into a switch-on state;
access an acquisition data structure that comprises one or more RPLMN identities associated with respective ones of a plurality of RATs;
determine whether the acquisition data structure includes at least one RPLMN identity in the one or more RPLMN identities that is associated with the first RAT; and
select the first cell of the first RPLMN when the acquisition data structure includes the at least one RPLMN identity that is associated with the first RAT.

17. The apparatus of claim 12, further comprising:
detecting an inter-radio access technology (IRAT) transition from the first RAT to a second RAT different than the first RAT;
determining whether an identifier of a second RPLMN associated with the second RAT is present in the UE; and
storing a second PLMN as the second RPLMN for the second RAT when the identifier of the second RPLMN is not present in the UE.

18. The apparatus of claim 17, further comprising:
obtaining the identifier of the second RPLMN associated with the second RAT from an acquisition data structure in the UE;
selecting a second cell of the second RPLMN in a second cell search; and
communicating, with the second cell, tracking area update (TAU) information.

19. The apparatus of claim 12, further comprising:
performing an inter-radio access technology (IRAT) transition from the first RAT to a second RAT different than the first RAT;
determining whether a last registered RPLMN identity associated with the second RAT is present in the UE;
performing a cell search in a second public land mobile network (PLMN) when the last registered RPLMN identity associated with the second RAT is not present in the UE;
selecting a second cell of the second PLMN for camping based on the cell search;
transmitting, to the second cell, a second request for registering the UE to the second PLMN;
receiving, from the second cell, a second response based on the second request, the second response indicating acceptance of a tracking area update in the second request; and
storing the second PLMN as the second RPLMN for the second RAT based on the acceptance of the tracking area update.

20. A computer-readable medium storing computer-executable program code for wireless communication at a user equipment (UE), the code when executed by at least one processor, cause the at least one processor to:
determine to request for a first service associated with a first radio access technology (RAT);
determine whether an identifier of a first registered public land mobile network (RPLMN) associated with the first RAT is present in the UE; and
camp on a first cell of the first RPLMN when the identifier of the first RPLMN is present in the UE.

21. The computer-readable medium of claim 20, wherein:
the code, which when executed by the at least one processor, further causes the at least one processor to transition into a switch-on state of the UE,
the determination to request for the first service comprises to receive, from a non-stratum access (NAS) layer of the UE, a request to access the first RAT for the first service, and
the determination of whether the identifier of the first RPLMN associated with the first RAT is present comprises to select the first RPLMN from a plurality of RPLMNs stored in an acquisition data structure in the UE when the identifier of first RPLMN is present in the UE, the first RPLMN being a last registered public land mobile network (PLMN) for the first RAT.

22. The computer-readable medium of claim 20, wherein the code, which when executed by the at least one processor, further causes the at least one processor to:
obtain the identifier of the first RPLMN from an acquisition data structure in the UE;
select the first cell of the first RPLMN in a first cell search;
transmit, to the first cell, a first request for registering the UE to the first RPLMN; and
receive, from the first cell, a response to the first request, the response indicating acceptance of the first request for registering the UE to the first RPLMN.

23. The computer-readable medium of claim 20, wherein the code, which when executed by the at least one processor, further causes the at least one processor to:
transition into a switch-on state;
determine whether a last registered RPLMN identity associated with the first RAT is present in the UE;
perform a cell search in a first public land mobile network (PLMN) when the last registered RPLMN identity associated with the first RAT is not present in the UE;
select the first cell of the first PLMN for camping based on the cell search;
transmit, to the first cell, a first request for registering the UE to the first PLMN;
receive, from the first cell, a first response based on the first request, the first response indicating a registration acceptance to register the UE to the first PLMN; and
store the first PLMN as the first RPLMN for the first RAT based on the registration acceptance.

24. The computer-readable medium of claim 20, wherein the code, which when executed by the at least one processor, further causes the at least one processor to:
detect a transition into a switch-on state;
access an acquisition data structure that comprises one or more RPLMN identities associated with respective ones of a plurality of RATs;
determine whether the acquisition data structure includes at least one RPLMN identity in the one or more RPLMN identities that is associated with the first RAT; and
select the first cell of the first RPLMN when the acquisition data structure includes the at least one RPLMN identity that is associated with the first RAT.

25. The computer-readable medium of claim 20, wherein the code, which when executed by the at least one processor, further causes the at least one processor to:
detect an inter-radio access technology (IRAT) transition from the first RAT to a second RAT different than the first RAT;
determine whether an identifier of a second RPLMN associated with the second RAT is present in the UE; and
store a second PLMN as the second RPLMN for the second RAT when the identifier of the second RPLMN is not present in the UE.

26. The computer-readable medium of claim 25, wherein the code, which when executed by the at least one processor, further causes the at least one processor to:
obtain the identifier of the second RPLMN associated with the second RAT from an acquisition data structure in the UE;
select a second cell of the second RPLMN in a second cell search; and
communicate, with the second cell, tracking area update (TAU) information.

27. The computer-readable medium of claim 20, wherein the code, which when executed by the at least one processor, further causes the at least one processor to:
perform an inter-radio access technology (IRAT) transition from the first RAT to a second RAT different than the first RAT;
determine whether a last registered RPLMN identity associated with the second RAT is present in the UE;
perform a cell search in a second public land mobile network (PLMN) when the last registered RPLMN identity associated with the second RAT is not present in the UE;
select a second cell of the second PLMN for camping based on the cell search;
transmit, to the second cell, a second request for registering the UE to the second PLMN;
receive, from the second cell, a second response based on the second request, the second response indicating acceptance of a tracking area update in the second request; and
store the second PLMN as the second RPLMN for the second RAT based on the acceptance of the tracking area update.

28. An apparatus for wireless communication at a user equipment (UE), comprising:
means for determining to request for a first service associated with a first radio access technology (RAT);
means for determining whether an identifier of a first registered public land mobile network (RPLMN) associated with the first RAT is present in the UE; and
means for camping on a first cell of the first RPLMN when the identifier of the first RPLMN is present in the UE.

29. The apparatus of claim 28, further comprising means for transitioning into a switch-on state of the UE,
wherein the means for determining to request for the first service is further configured to receive, from a non-stratum access (NAS) layer of the UE, a request to access the first RAT for the first service, and
wherein the means for determining whether the identifier of the first RPLMN associated with the first RAT is present is further configured to select the first RPLMN from a plurality of RPLMNs stored in an acquisition data structure in the UE when the identifier of first RPLMN is present in the UE, the first RPLMN being a last registered public land mobile network (PLMN) for the first RAT.

30. The apparatus of claim 28, further comprising:
means for transitioning into a switch-on state;
means for determining whether a last registered RPLMN identity associated with the first RAT is present in the UE;
means for performing a cell search in a first public land mobile network (PLMN) when the last registered RPLMN identity associated with the first RAT is not present in the UE;
means for selecting the first cell of the first PLMN for camping based on the cell search;
means for transmitting, to the first cell, a first request for registering the UE to the first PLMN;
means for receiving, from the first cell, a first response based on the first request, the first response indicating a registration acceptance to register the UE to the first PLMN; and
means for storing the first PLMN as the first RPLMN for the first RAT based on the registration acceptance.
